(19) United States
(12) Patent Application Publication
(10) Pub. No.: US 2022/0244119 A1
(43) Pub. Date: Aug. 4, 2022

(54) Rotation Angle Measuring Device for Hand Tool

(71) Applicant: KABO Tool Company, Taichung City (TW)

(72) Inventor: Chih-Ching Hsieh, Taichung City (TW)

(21) Appl. No.: 17/648,814

(22) Filed: Jan. 25, 2022

(30) Foreign Application Priority Data
Feb. 4, 2021 (TW) 110104224

(51) Int. Cl. G01L 3/10; G01D 5/14; G01B 7/30

(52) U.S. Cl. CPC G01L 3/104; G01B 7/30; G01D 5/145

(57) ABSTRACT

A rotation angle measuring device for a hand tool is mounted in or coupled to the hand tool, can be rotated along with the hand tool, and includes a housing, a control unit, an input unit, an electronic angle detection unit, and a display unit. The angle detection unit is configured to detect the orientation of the Earth's magnetic field, the rotation angle of the hand tool, the tilt angle of the hand tool with respect to a horizontal plane, and the tilt angle of the hand tool in a vertical plane. The control unit is configured to compensate for the tilt angles of the hand tool so that the rotation angle of the hand tool can be correctly measured even if the hand tool is operated in a tilted state.

### BACKGROUND OF THE INVENTION

### 1. Technical Field

The present invention relates to the detection of a rotation angle and more particularly to a rotation angle measuring device that can work with or be directly mounted in or on a hand tool to measure the rotation angle of the hand tool.

### 2. Description of Related Art

Hand tools are often used in our daily lives and are nowadays provided with a variety of functions in order to have a wider range of applications and higher operational precision. For example, a torque wrench may have several built-in functional elements such as a torque detection element and an angle detection element for respectively detecting the torque applied by the torque wrench and the rotation angle of the torque wrench during operation, the objective being to complete work with enhanced precision.

Existing wrenches typically use a gyroscope as their angle detection element. A gyroscope, however, can only be used horizontally and will produce an error if used in a tilted state. Referring to FIG. 1, the wrench 10 must be operated in a horizontal plane P, or the tilt angle of the wrench 10 must be within ±8 degrees from the horizontal plane P, in order for the gyroscope in the wrench 10 to detect the rotation angle of the wrench correctly. If the tilt angle of the wrench 10 exceeds 8 degrees, the value detected by the gyroscope will have an error and therefore be inaccurate.

In addition, referring to FIG. 2, if the handle 16 of the wrench 12 can be angularly displaced with respect to the head portion 14 of the wrench in the vertical direction, the handle 16, where a gyroscope is provided, must be at a horizontal position or within ±8 degrees from the horizontal position in order for the gyroscope to detect the rotation angle of the wrench correctly. If the handle 16 is not horizontal or is outside the ±8 degree range, the detected angle will be inaccurate.

It can be known from the above that the prior art of detecting the rotation angle of a wrench with a gyroscope has many limitations in use. There are, however, numerous operation scenarios or threaded fastener positions that do not allow the wrench 10 to be used in the horizontal plane P or the handle 16 of the wrench 12 to stay horizontal. In consequence, it is not always possible to measure the rotation angle of a hand tool correctly, and this demands improvement.

Besides, when the gyroscope in a hand tool produces an error, the user of the hand tool cannot calibrate the gyroscope by themselves. The hand tool must be sent back to its manufacturer in order for the manufacturer to calibrate the gyroscope with an angle plate.

### BRIEF SUMMARY OF THE INVENTION

The primary objective of the present invention is to provide a rotation angle measuring device for a hand tool, wherein the rotation angle measuring device can work with or be directly mounted in or on the hand tool to measure the rotation angle of the hand tool accurately, regardless of the space or use scenario (including a tilted working state) the hand tool is in.

Another objective of the present invention is to provide a rotation angle measuring device for a hand tool, wherein the rotation angle measuring device can be calibrated by its user in order to restore its accuracy.

The rotation angle measuring device provided by the present invention for a hand tool is mounted in or coupled to the hand tool, can be rotated along with the hand tool, and includes a housing, a control unit, an input unit, an electronic angle detection unit, a display unit, and a power source.

The control unit is configured to receive, compute, compare, and execute various instructions and commands.

The input unit is electrically connected to the control unit and is configured to enable the input of numerical values.

The electronic angle detection unit is configured to detect of the orientation of the Earth's magnetic field, the rotation angle of the hand tool, the tilt angle of the hand tool with respect to a horizontal plane, and the tilt angle of the hand tool in a vertical plane. The control unit is configured to perform tilt angle compensation based on the detected tilt angles.

The display unit is provided on the housing, is electrically connected to the control unit, and is configured to display various data and information, including the rotation angle of the hand tool.

The power source provides electricity.

Thanks to the tilt angle compensation, the rotation angle of the hand tool can be correctly measured to ensure the accuracy of the work performed by the hand tool, even if the hand tool is operated in a tilted state.

Preferably, the angle detection unit is a three-dimensional electronic compass and has a three-axis accelerometer and a three-axis magnetometer. The three-axis accelerometer is configured to measure the tilt angles of the electronic compass, and the three-axis magnetometer is configured to detect the orientation of the Earth's magnetic field.

Preferably, the angle detection unit can also detect the temperature of the environment where the hand tool is, and the control unit can perform temperature compensation based on the detected temperature.

The rotation angle measuring device can be calibrated by its user. The user only has to move the rotation angle measuring device in circles in order to complete the calibration of the angle detection unit. The calibration can be carried out with ease.

Preferably, the rotation angle measuring device is mounted in a hand tool that has a main body, and the main body forms the housing of the rotation angle measuring device.

Preferably, the housing has a coupling portion, and the coupling portion is configured to be coupled to the hand tool in a detachable manner so that the rotation angle measuring device can be coupled to and separated from the hand tool.

Preferably, the input unit includes an angle zeroing button. When the angle zeroing button is pressed, the angle detection unit sets the current orientation of the Earth's magnetic field as a zero-degree angle.

### BRIEF DESCRIPTION OF THE SEVERAL VIEWS OF THE DRAWINGS

In order for the examiner to better understand the objectives, features, and intended effect of the present invention, several preferred embodiments of the invention are detailed below with reference to the accompanying drawings, in which:

FIG. 1 is an end view of a conventional wrench;

FIG. 2 is a side view of a conventional wrench, showing that the handle of the wrench can be pivoted vertically;

FIG. 3 is a perspective view of a hand tool using the rotation angle measuring device according to a preferred embodiment of the present invention, wherein the hand tool is an electronic torque wrench, and the rotation angle measuring device is mounted in the electronic torque wrench as a built-in component;

FIG. 4 is a perspective view of a hand tool using the rotation angle measuring device according to another preferred embodiment of the invention, wherein the hand tool is a wrench, and the rotation angle measuring device is coupled to the wrench;

FIG. 5 is a perspective view of a hand tool using the rotation angle measuring device according to yet another preferred embodiment of the invention, wherein the hand tool is a non-wrench hand tool, and the rotation angle measuring device is coupled to the hand tool;

FIG. 6 is an end view of the assembly in FIG. 5;

FIG. 7 is a circuit block diagram of the rotation angle measuring device of the invention;

FIG. 8 is a schematic structural diagram of the electronic compass in the invention;

FIG. 9 and FIG. 10 respectively show two states of use of a hand tool mounted with the rotation angle measuring device of the invention;

FIG. 11 shows different states of use of a hand tool mounted with the rotation angle measuring device of the invention;

FIG. 12 is a perspective view of a hand tool using the rotation angle measuring device according to still another preferred embodiment of the invention, wherein the hand tool is a wrench, and the rotation angle measuring device is coupled to the wrench;

FIG. 13 shows an operation flowchart of the invention;

FIG. 14 schematically shows how to calibrate the angle detection unit in the invention; and

FIG. 15 is a plot showing how the magnetic induction of the angle detection unit in the invention is calibrated.

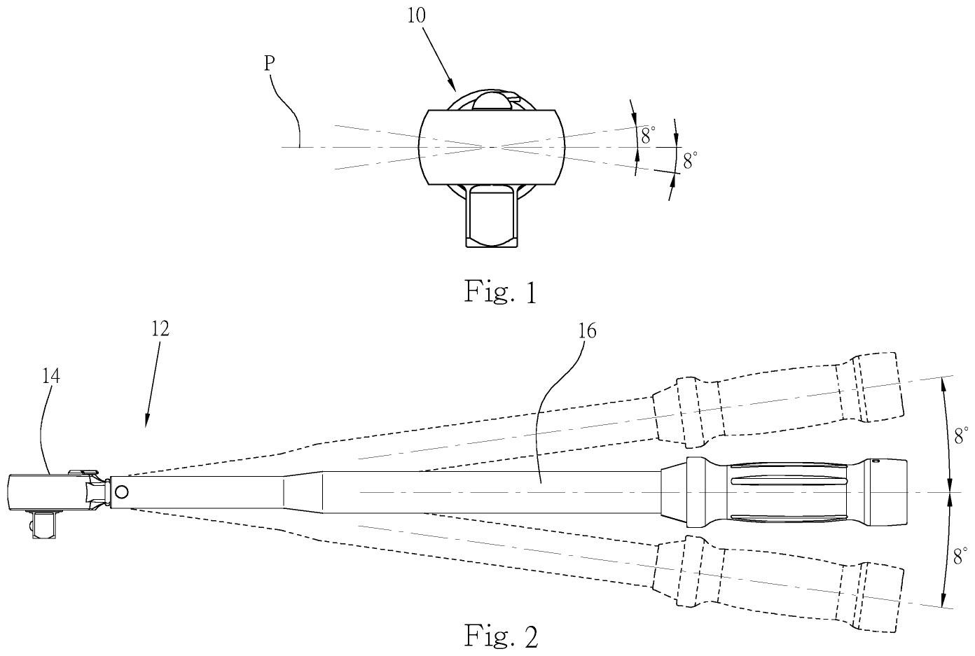

### DETAILED DESCRIPTION OF THE INVENTION

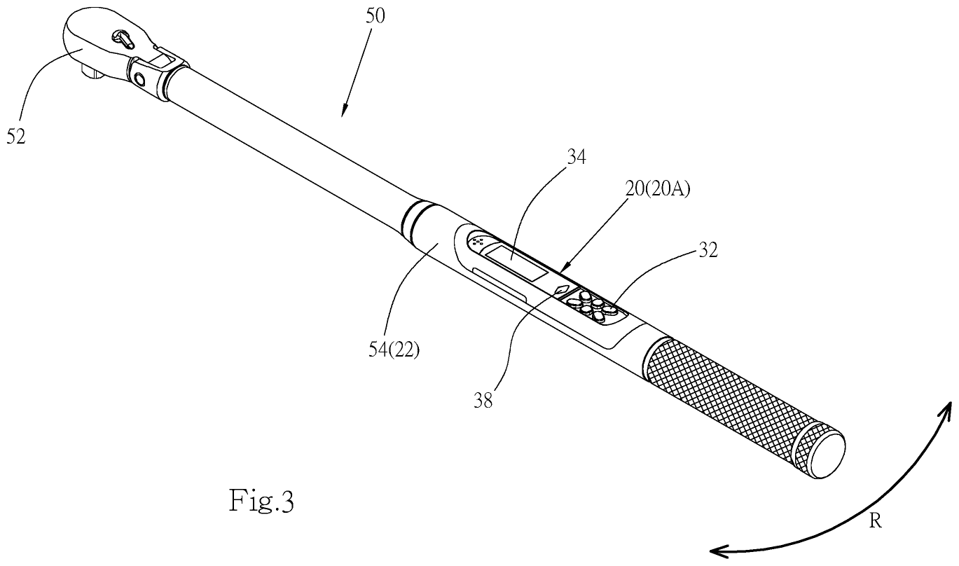

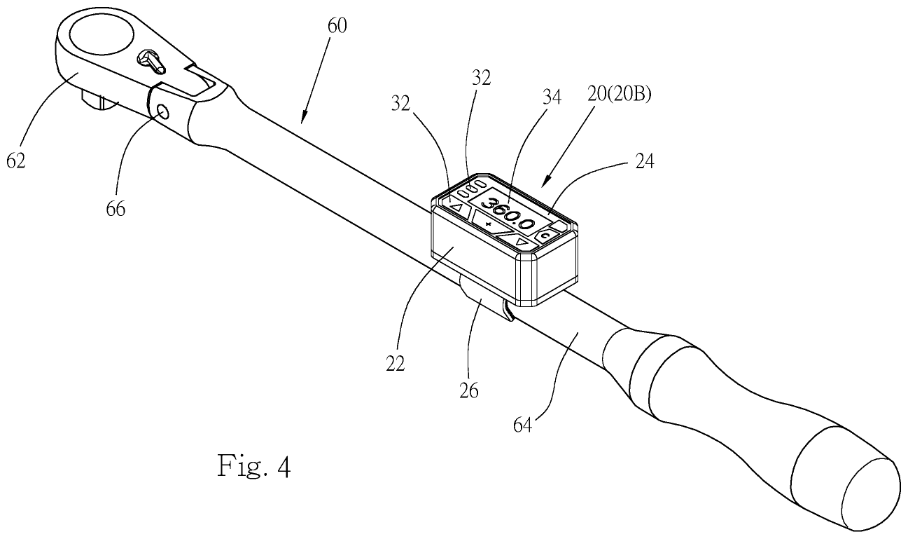

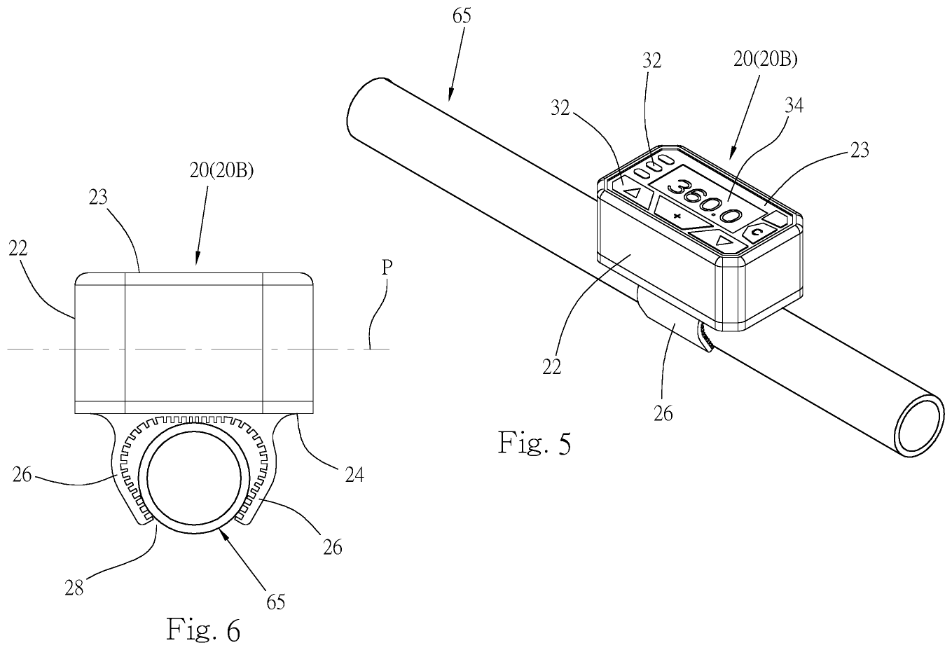

The present invention provides a rotation angle measuring device (hereinafter also referred to as the angle measuring device for short) 20 (20A, 20B) for use by a hand tool to measure the rotation angle of the hand tool. As used herein, the term “hand tool” refers to any hand tool that can be used to lock a threaded fastener, including any wrench, socket, connecting rod to be connected with a wrench or socket, or other similar hand tools. The term “rotation angle” refers to the angle through which a hand tool is rotated in order to rotate a threaded fastener (e.g., a bolt or nut), i.e., the angle through which the wrench in FIG. 3 is rotated in a direction R in order to rotate a threaded fastener. As shown in FIG. 3, the rotation angle measuring device 20 (20A) of the invention may be a built-in component of the wrench 50 or of a non-wrench hand tool such as a socket, a connecting rod, or the like. Alternatively, the angle measuring device 20 (20B) may be an independent device configured to be coupled to a hand tool in a fixed or detachable manner as shown in FIG. 4, in which the angle measuring device 20 (20B) is coupled to a wrench 60, or FIG. 5, in which the angle measuring device 20 (20B) is coupled to a non-wrench hand tool 65 such as a socket, a connecting rod, or other similar hand tools. As used herein, the reference numeral “20” refers collectively to the angle measuring device of the invention in various configurations, including those made as a built-in component of a hand tool and those made as an independent angle measuring device; the reference numeral “20A” refers specifically to an angle measuring device made as a built-in component of a hand tool; and the reference numeral “20B” refers specifically to an angle measuring device made as an independent device.

Referring to FIG. 7, the angle measuring device 20 of the present invention has a housing 22 (see FIG. 3 to FIG. 6 and FIG. 12) and the following elements mounted in the housing 22: a control unit 30, an input unit 32, a display unit 34, an electronic angle detection unit 36, an alert unit 38, a memory unit 40, and a power source 42. The housing 22 is provided therein with a circuit board (not shown). The control unit 30, the input unit 32, the display unit 34, the angle detection unit 36, the alert unit 38, and the memory unit 40 are either provided on or electrically connected to the circuit board. The power source 42 provides the electricity required to sustain operation of the angle measuring device 20. The power source 42 may be a battery.

When mounted in a hand tool (e.g., a wrench, socket, or connecting rod), the angle measuring device 20 (20A) is mounted in the main body of the hand tool. Take the electronic torque wrench 50 in FIG. 3 for example. The wrench 50 has a main body that includes a head portion 52 and a tubular handle 54. The main body of the wrench forms the housing of the angle measuring device 20 (20A). In this embodiment, the tubular handle 54 is the housing 22 of the angle measuring device 20 (20A), and the control unit 30, the input unit 32, the display unit 34, the angle detection unit 36, the alert unit 38, the memory unit 40, the aforesaid circuit board, and the power source 42 are mounted in the handle 54 (i.e., the housing 22). Similarly, the wrench 60 in FIG. 4 has a head portion 62 and a handle 64. The head portion 62 and the handle 64 are pivotally connected by a pivot shaft 66 so that the handle 64 can be angularly displaced in the vertical direction about a center of rotation defined by the pivot shaft 66.

When the hand tool is a socket, the socket body constitutes the main body of the socket, and when the angle measuring device 20 (20A) is mounted in the socket, the socket body is the housing of the angle measuring device 20 (20A) and houses the other components of the angle measuring device. When the hand tool is a connecting rod, the rod body of the connecting rod constitutes the main body of the connecting rod, and when the angle measuring device 20 (20A) is mounted in the connecting rod, the rod body of the connecting rod is the housing of the angle measuring device 20 (20A).

When the angle measuring device 20 (20B) is made as an independent device, referring to FIG. 4 to FIG. 6, the housing 22 is a hollow rectangular body with a top side 23 and a bottom side 24. The display unit 34 and the input unit 32 are provided on the top side 23 of the housing 22. The control unit 30, the electronic detection unit 36, the alert unit 38, the memory unit 40, the aforesaid circuit board, and the power source 42 are provided in the housing 22. To make it easier to couple the device to various wrenches or non-wrench hand tools 65, the device 20B of the present invention is provided with a coupling portion with which the device 20B can be coupled to a hand tool. In this embodiment, the bottom side 24 of the housing 22 is provided with a pair of fastening lugs 26 and an opening 28 formed between the free ends of the two fastening lugs so that a hand tool can be placed in the space between the two fastening lugs 26. The two fastening lugs 26 are configured to open and close elastically so as to be able to be clamped on and separated from the wrench 60 or the hand tool 65. The inner sides of the two fastening lugs 26 are each provided with several anti-slip protruding strips so that the device 20 (20B) can be connected securely to the wrench 60 or the hand tool 65.

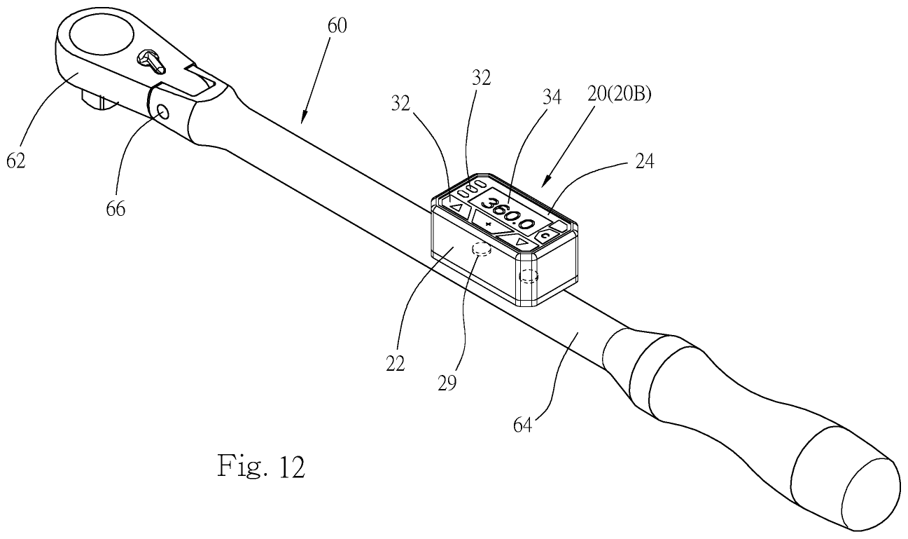

Referring to FIG. 12, the coupling portion may alternatively be one, or more than one, magnetic element (e.g., magnet) 29, allowing the angle measuring device 20 (20B) to be magnetically attached to and detached from a hand tool. The coupling portion is not limited to the fastening lugs 26 or the magnetic element 29 and may also be a strap, adhesive, or one of a matching pair of male and female elements of an engaging/connecting structure, with the other of the male and female elements provided on the hand tool to which the angle measuring device is to be coupled.

The control unit 30 may be a micro control unit (MCU) or central processing unit (CPU) configured to receive, compute, compare, and execute various instructions and commands.

The input unit 32 is electrically connected to the control unit 30 and is so configured that a user can input various information and numerical values (including the angle value to be set) into the rotation angle measuring device 20 through the input unit 32. The input unit 32 may be physical buttons or touch-controlled buttons and may further include a button for turning on the rotation angle measuring device 20, a button for turning off the rotation angle measuring device 20, an angle sensing button, and an UP button and a DOWN button for adjusting the input numerical value. The aforesaid buttons may be a single button or a plurality of buttons that have different functions respectively. The method for setting a numerical value may entail pressing the UP button or DOWN button repeatedly or, if number buttons representing 0 to 9 respectively are provided, directly pressing selected ones of the number buttons to form the numerical value to be input. The electronic torque wrench 50 in FIG. 3 further includes a torque sensing element for sensing the torque applied, allows the desired torque value to be set, and can display torque values.

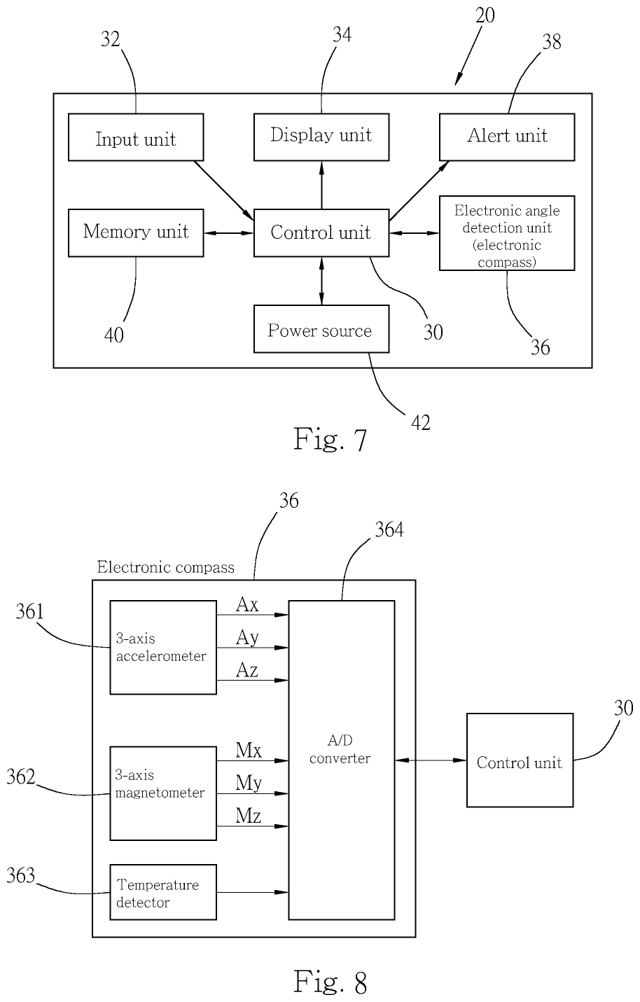

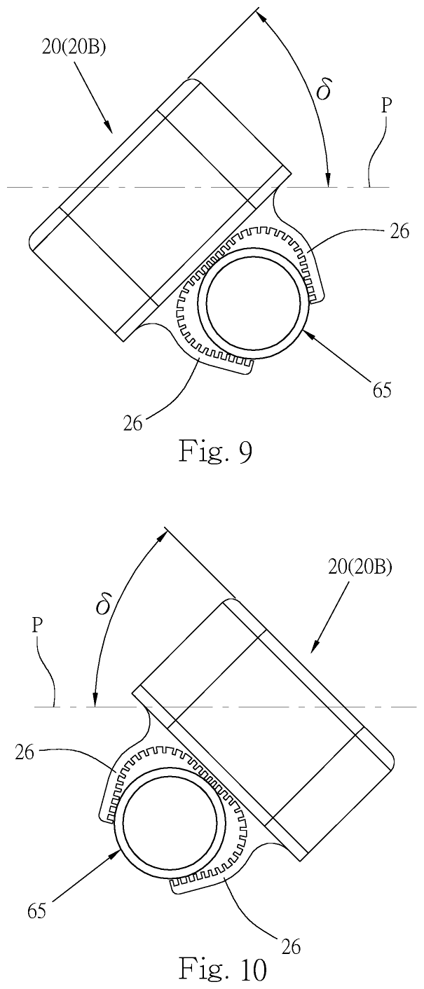

The electronic angle detection unit 36 in this embodiment is a three-dimensional electronic compass and is electrically connected to the control unit 30. Referring to FIG. 8, the electronic compass (electronic detection unit) 36 has a three-axis accelerometer (G sensor) 361, a three-axis magnetometer 362, and a temperature detector 363. The three-axis accelerometer 361 is configured to measure the tilt state and tilt angles of the electronic compass 36. When the electronic compass 36 is tilted, the three-axis accelerometer 361 can compensate for the tilt angles by way of gravity data and a vector relationship. The three-axis magnetometer 362 is configured to measure the orientation of the Earth's magnetic field. The temperature detector 363 is configured to measure the temperature of the environment. The electronic compass 36 uses the three-axis magnetometer 362 to detect the north/south pole of the Earth and the three-axis accelerometer 361 to measure the tilt angles of the electronic compass 36 so that tilt angle compensation can be carried out. The electronic compass 36 further uses the temperature detector 363 to detect changes in temperature so that temperature compensation can be performed accordingly to prevent a temperature difference from causing a temperature drift of the tilt angles and of the orientation angles. The numerical values measured by the magnetometer 362, the accelerometer 361, and the temperature detector 363 are converted into digital signals by an analog-to-digital converter (A/D converter) 364, and the digital signals are sent to the control unit 30 for computation in order to calculate the orientation/angles of the electronic compass 36. The tilt angle compensation and temperature compensation allow the measurement of the Earth's magnetic field by the electronic compass 36 to be accurate, without being affected by the tilt angles or location of the electronic compass 36, the space where the electronic compass 36 is in, or the temperature of the space.

The electronic compass 36 is configured to detect the rotation angle of the wrench 50, wrench 60, or hand tool 65 in operation, generate a corresponding angle detection signal, and thereby send the detected angle value to the control unit 30 so that the change in angle, in position, in speed, and in working direction of the wrench 50, wrench 60, or hand tool 65 during operation can be accurately detected.

The display unit 34 is a liquid crystal screen, is electrically connected to the control unit 30, and is configured to display various data and information to be read by the user, including the preset angle value input through the input unit 32, the angle values detected by the electronic compass 36, and the related computation results.

The alert unit 38 is electrically connected to the control unit 30 and is configured to issue an alert or produce a warning signal when receiving an instruction or command from the control unit 30 after the control unit 30 computes and compares the numerical values detected by the electronic compass 36 and the preset value input through the input unit 32. The alert unit 38 may produce an alerting effect by way of light, sound, voice output, or vibrations. For example, the alert unit 38 may be an indicator light, an LED (light-emitting diode) lamp, one or more color lights, a buzzer, or a vibrator.

The memory unit 40 is electrically connected to the control unit 30 and is configured to store the at least one angle value detected by the electronic detection unit 36, the at least one preset angle value input by a user through the input unit 32, and other numerical values needed for operation.

This and the following paragraphs describe how the angle measuring device 20 of the present invention works when a hand tool mounted with the angle measuring device 20 is used. Referring to FIG. 6, when the hand tool 65 is rotated in such a way that it stays parallel to the horizontal plane P without being tilted, the electronic compass 36 detects the rotation angle of the hand tool 65. When the hand tool 65 is rotated in such a way that it is tilted at a large angle with respect to the horizontal plane P, e.g., at a tilt angle δ with respect to the horizontal plane as shown in FIG. 9 or FIG. 10, the electronic compass 36 detects the tilt angle δ as well as the rotation angle of the hand tool 65 and sends the detected rotation angle along with the tilt angle information to the control unit 30 in order for the control unit 30 to perform software-based computation, carry out tilt angle compensation and temperature compensation, and thereby correct the detected rotation angle of the hand tool. Now that the electronic compass 36 can compensate for the tilt angle, the angle measuring device 20 (20B) can measure the rotation angle of the hand tool 65 accurately even when the hand tool is operated in the tilted states shown in FIG. 9 and FIG. 10.

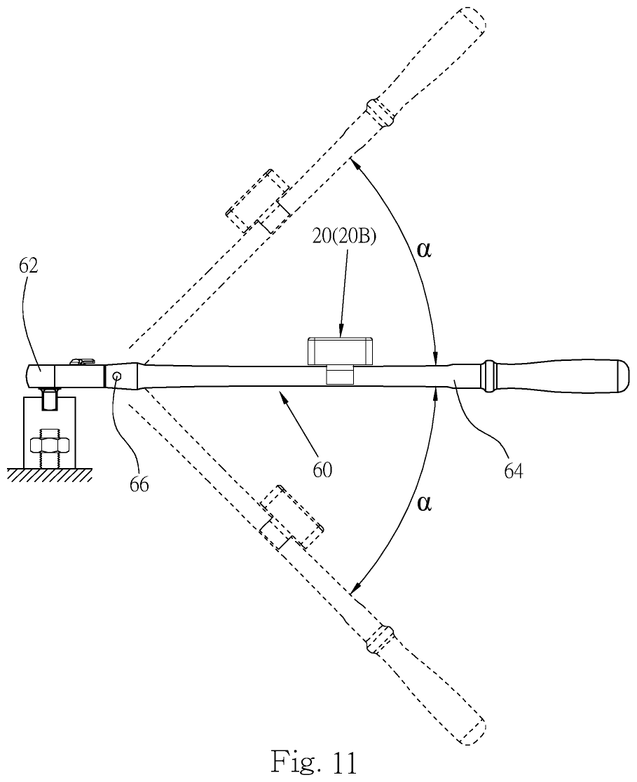

Similarly, when the handle of the hand tool has a tilt angle in a vertical plane, referring to the wrench 60 in FIG. 11 for example, the electronic compass 36 can detect the tilt angle of the handle 64 of the wrench and ambient temperature regardless of whether the handle 64 is tilted upward or downward at a tilt angle α. With the electronic compass 36 detecting the tilt angle and temperature, and the control unit 30 performing tilt angle compensation and temperature compensation, the angle measuring device 20 (20B) can measure the rotation angle of the hand tool 65 accurately even when the handle 64 of the wrench 60 is operated in the tilted states shown in FIG. 11.

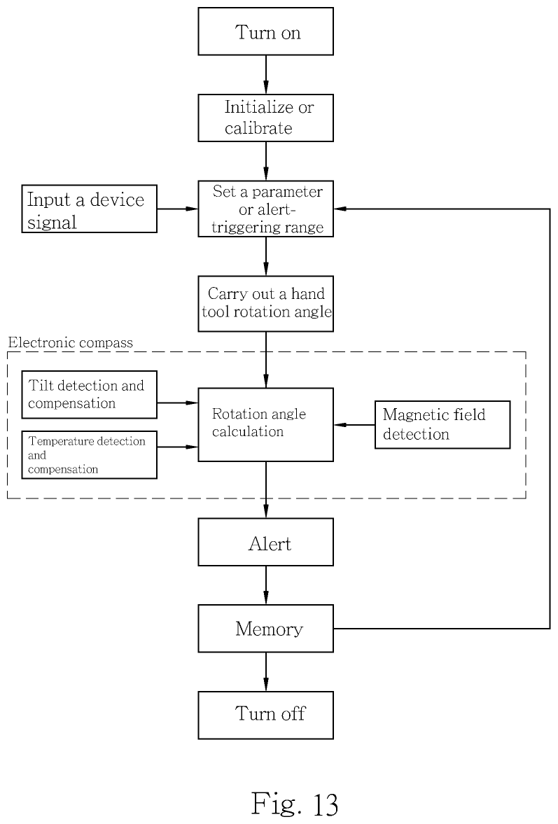

FIG. 13 shows a flowchart of use of the wrench 50, wrench 60, or hand tool 65 employing the angle measuring device 20 (20A, 20B) of the present invention.

The first step is to turn on the angle measuring device 20 by pressing the switch of the input unit 32.

The second step is to initialize (zero) or calibrate the angle measuring device 20. In this step, the electronic compass 36 detects the orientation of the Earth's magnetic field and takes the magnetic field orientation at the time of the detection as the initial angle, i.e., zero-degree angle, of the rotation operation to be performed.

In the third step, the user inputs a parameter or an alert-triggering range through the input unit 32 so as to set the value of the angle through which a threaded fastener is to be rotated with the hand tool.

In the fourth step, the user rotates the threaded fastener (e.g., a bolt or nut) by rotating the hand tool.

In the fifth step, the three-axis accelerometer 361, the three-axis magnetometer 362, and the temperature detector 363 of the electronic compass 36 respectively detect the tilt state of the hand tool, the orientation of the Earth's magnetic field at that time, and the temperature of the location of the hand tool. Then, after tilt compensation (tilt angle compensation) and temperature compensation, the rotation angle of the hand tool is calculated. The rotation angle of the hand tool is the change between the orientation of the Earth's magnetic field at the latter time and the orientation of the Earth's magnetic field that defines the initial angle. The rotation angle of the hand tool may be less than 360 degrees or greater than 360 degrees.

In the sixth step, the value of the post-compensation detected rotation angle is displayed by the display unit 34. Referring to FIG. 4 and FIG. 5 for example, the display unit 34 displays 360.0, indicating that the hand tool has been rotated through an angle of 360 degrees, and that the numerical value displayed by the display unit is precise to the first digit after the decimal point. Furthermore, the control unit 30 compares the post-compensation detected rotation angle with the preset rotation angle value. If the rotation angle of the hand tool has reached the preset value, the control unit 30 will send out an instruction or command that makes the alert unit 38 issue an alert, e.g., a light-based, sound-based, or vibration-based alert, thereby alerting the user to the fact that the preset rotation angle has been reached, and warning the user not to rotate the hand tool any further.

In the seventh step, the control unit 30 instructs the memory unit 40 to store the operation information (including each rotation angle of the hand tool and the sum of all the rotation angles during operation) for future reference and for use as a criterion by which to determine the work condition of the hand tool. The angle measuring device 20 is turned off when all the work to be done therewith is completed.

Besides, the buttons of the input unit include an angle zeroing button. Once the user has completed the rotation of a threaded fastener and is about to rotate the next threaded fastener with the hand tool, the angle zeroing button can be pressed in order for the electronic compass 36 to take the currently detected orientation of the Earth's magnetic field as the zero-degree angle of the rotation operation to be performed, i.e., the initial angle with which to calculate the rotation angle of the hand tool. Thus, the zero-degree angle of a rotation operation can be obtained immediately without having to restart the angle measuring device 20.

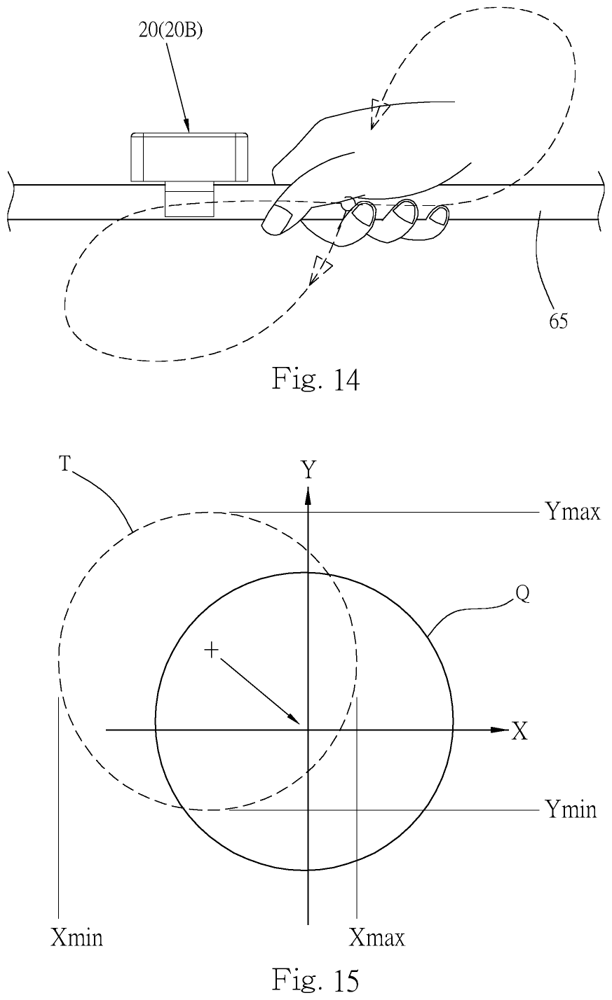

Furthermore, as the north and south poles of the Earth have fixed polar directions, the present invention allows a user of the angle measuring device 20 to calibrate the electronic compass 36 by themselves. More specifically, the electronic compass 36 can be calibrated by the user moving the angle measuring device 20 in circles. Referring to FIG. 14 for example, a user may carry out the calibration by moving the angle measuring device 20 back and forth along an 8-shaped moving path several times while directly holding the angle measuring device 20 (20B) or holding the hand tool instead, the objective being to obtain the greatest values (Xmax, Ymax) and smallest values (Xmin, Ymin) of the magnetic induction of the electronic compass 36 as shown in FIG. 15 and hence the shifted magnetic induction T, which is subsequently restored to the correct magnetic induction Q by software-based calibration to complete the calibration of the electronic compass 36.

The rotation angle measuring device 20 provided by the present invention can measure the rotation angle of a hand tool accurately. The measured value will not be affected by the tilt state of the hand tool, the environment or space where the hand tool is, or the temperature of the environment or space. Precise measurement can be achieved even if the hand tool is tilted at a large angle or is used in a low-temperature or high-temperature environment.

In addition, the present invention makes it possible for a user to calibrate the rotation angle measuring device 20 and thereby maintain the accuracy of angle measurement. The calibration method is simple and can be easily performed.

The embodiments described above serve only to expound, but not to limit, the present invention. All equivalent modifications of the invention shall fall within the scope of the patent protection sought by the applicant. The technique of the invention is the first of its kind in the art and provides an improvement of a practical function; therefore, a patent application for the invention is hereby filed according to law.

What is claimed is:

1. A rotation angle measuring device for a hand tool, the rotation angle measuring device being mounted in or coupled to the hand tool and rotatable along with the hand tool, the rotation angle measuring device comprising:
a housing;
a control unit provided in the housing and configured to receive, compute, compare, and execute various instructions and commands;
an input unit provided on the housing, electrically connected to the control unit, and configured to enable input of numerical values;
an electronic angle detection unit provided in the housing, electrically connected to the control unit, and configured to detect an orientation of the Earth's magnetic field, a rotation angle of the hand tool, a tilt angle of the hand tool with respect to a horizontal plane, and a tilt angle of the hand tool in a vertical plane, wherein the control unit is configured to perform tilt angle compensation based on the detected tilt angles in order to obtain a correct rotation angle;
a display unit provided on the housing, electrically connected to the control unit, and configured to display various data and information, including the correct rotation angle; and
a power source for providing electricity required by the rotation angle measuring device.

2. The rotation angle measuring device of claim 1, wherein the angle detection unit is a three-dimensional electronic compass and has a three-axis accelerometer for measuring tilt angles of the electronic compass and a three-axis magnetometer for detecting the orientation of the Earth's magnetic field.

3. The rotation angle measuring device of claim 1, wherein the angle detection unit is configured to be calibrated by moving the rotation angle measuring device in circles.

4. The rotation angle measuring device of claim 1, wherein the angle detection unit is configured to detect a temperature, and the control unit is configured to perform temperature compensation based on the detected temperature in order to obtain the correct rotation angle.

5. The rotation angle measuring device of claim 4, wherein the angle detection unit includes a temperature detector for detecting the temperature.

6. The rotation angle measuring device of claim 1, wherein the rotation angle measuring device allows a rotation angle value to be set and further comprises an alert unit provided in the housing and electrically connected to the control unit so that when the correct rotation angle reaches the set rotation angle value, the control unit drives the alert unit to issue an alert.

7. The rotation angle measuring device of claim 1, further comprising a memory unit, wherein the memory unit is provided in the housing, is electrically connected to the control unit, and is configured to store information including the correct rotation angle.

8. The rotation angle measuring device of claim 1, wherein the rotation angle measuring device is mounted in the hand tool, the hand tool has a main body, and the main body forms the housing of the rotation angle measuring device.

9. The rotation angle measuring device of claim 1, wherein the housing has a coupling portion, and the coupling portion is configured to be coupled to the hand tool in a detachable manner.

10. The rotation angle measuring device of claim 9, wherein the housing has a surface provided with a pair of fastening lugs, an opening is formed between free ends of the two fastening lugs, and the rotation angle measuring device is clamped on the hand tool via the two fastening lugs.

11. The rotation angle measuring device of claim 9, wherein the housing has a surface provided with at least one magnetic element, and the rotation angle measuring device is magnetically attached to the hand tool via the magnetic element.

12. The rotation angle measuring device of claim 1, wherein the input unit includes an angle zeroing button, and when the angle zeroing button is pressed, the angle detection unit sets a current said orientation of the Earth's magnetic field as a zero-degree angle.
